(19) United States
(12) Patent Application Publication
(10) Pub. No.: US 2018/0015003 A1
(43) Pub. Date: Jan. 18, 2018

(54) Baby Bottle with Interior Container for Feeding Liquid and Outer Container for Heating Liquid

(71) Applicant: Corinne Louise Miller, Winnipeg (CA)

(72) Inventor: Corinne Louise Miller, Winnipeg (CA)

(21) Appl. No.: 15/648,953

(22) Filed: Jul. 13, 2017

Related U.S. Application Data
(60) Provisional application No. 62/361,574, filed on Jul. 13, 2016.

(51) Int. Cl. A61J 9/00; A47J 36/24; A61J 11/04

(52) U.S. Cl. CPC A61J 9/00; A61J 11/04; A47J 36/2411; A61J 2200/42

(57) ABSTRACT

A baby bottle features an interior container for containing a feeding liquid that has an open top, a nipple closing the interior container at its top so that the feeding liquid is contained in the interior container but withdrawable therefrom through the nipple, and an outer container that collectively defines an interior volume in which the interior container is received. The outer container is arranged for containing a heating liquid which is placed in communication with an outer surface of the interior container to heat the feeding liquid by transfer of heat thereto from the heating liquid. The outer container includes a removable cap at its bottom such that the heating liquid may be introduced into the outer container through the bottom to a space delimited by the outer container about the interior container when the cap is removed.

### FIELD OF THE INVENTION

The present invention relates to a container arrangement which is particularly suited in the form of a baby bottle but is not limited thereto. The container arrangement has an interior container with a mouthpiece where a first liquid intended for consumption is contained. The interior container is received in an interior volume of an outer container for containing a second liquid in a portion of the interior volume formed between walls of the interior container and those of the outer container. Typically, the second liquid is used as a heat source for heating and maintaining warmth of the first liquid by means of heat transfer from one liquid to the other primarily through the walls of the interior container.

### BACKGROUND

It is widely known by parents with newborn babies that baby formula is preferably served warm. Conventionally, warm/hot water has been used to warm the formula for serving. For example, a conventional baby bottle may be placed in a hot water bath or the conventional baby bottle may be placed under a faucet running hot water.

The applicant has developed a novel container arrangement which is advantageous for use as a baby bottle, where in this example baby formula may be heated using another contained liquid acting as a source of heat such as warm/hot water contained within the container arrangement.

### SUMMARY OF THE INVENTION

According to an aspect of the invention there is provided a baby bottle comprising:

an interior container for containing a feeding liquid that has an open top, a closed bottom, and a peripheral wall spanning therebetween;

a nipple at the open top of the interior container thereby closing the interior container so that the feeding liquid is contained in the interior container but withdrawable therefrom through the nipple;

an outer container having a top, a bottom, and a peripheral wall spanning therebetween that collectively define an interior volume of the outer container;

the interior container being received in the interior volume;

the outer container being arranged for containing a heating liquid which acts as a heat source for heating the feeding liquid by transfer of heat from the heating liquid in communication with an outer surface of the interior container to the feeding liquid contained therein;

the outer container including a removable cap at the bottom thereof such that the heating liquid may be introduced into the outer container through the bottom to a space delimited by the outer container about the interior container when the cap is removed.

According to another aspect of the invention there is provided a method for preparing feeding liquid to be consumed by a baby, the method comprising:

providing a baby bottle comprising:
an interior container for containing a feeding liquid that has an open top, a closed bottom, and a peripheral wall spanning therebetween;
a nipple at the open top of the interior container thereby closing the interior container so that the feeding liquid is contained in the interior container but withdrawable therefrom through the nipple;
an outer container having a top, a bottom, and a peripheral wall spanning therebetween that collectively define an interior volume of the outer container;
the interior container being received in the interior volume;
the outer container being arranged for containing a heating liquid which acts as a heat source for heating the feeding liquid by transfer of heat from the heating liquid in communication with an outer surface of the interior container to the feeding liquid contained therein;
the outer container including a removable cap at the bottom thereof such that the heating liquid may be introduced into the outer container through the bottom to a space delimited by the outer container about the interior container when the cap is removed;

providing the feeding liquid;

providing the heating liquid;

with the nipple removed and the baby bottle oriented such that the open top of the interior container is facing upwardly, transferring the feeding liquid into the interior container allowing the baby food to be consumed therefrom;

with the baby bottle oriented such that the bottom of the outer container is facing upwardly, transferring the heating liquid into the outer container through the bottom thereof as the cap is removed so as to fill the space about the interior container with the heat source for heating the feeding liquid.

Preferably the outer container comprises a tubular shell forming the peripheral wall of the outer container that receives at its bottom the removable cap so as to close the outer container at the bottom of the shell.

In one arrangement the removable cap threadably engages an outer face of the peripheral wall of the outer container.

In other arrangements the removable cap may for example form a plug in an opening at the bottom of the outer container.

Typically the closed bottom of the interior container is spaced from the bottom of the outer container so as to be located intermediate the top and bottom of the outer container.

The interior container and outer container may enclose a longitudinal axis of the baby bottle, and preferably the peripheral wall of the outer container is spaced radially from the peripheral wall of the interior container along a length of the interior container from the open top to the bottom thereof.

In one arrangement the interior container is made from a flexible plastic material.

Preferably, the interior container has at its top a lip at which the interior container is connected to the outer container and from which the interior container depends into the interior volume of the outer container.

Preferably, the lip is rested on a top of the peripheral wall of the outer container.

Preferably, the baby bottle further includes a collar sandwiching the nipple and the interior container onto the top of the outer container.

### BRIEF DESCRIPTION OF THE DRAWINGS

The invention will now be described in conjunction with the accompanying drawings in which:

FIG. 1 is a vertical cross-sectional view of an embodiment of baby bottle according to the present invention.

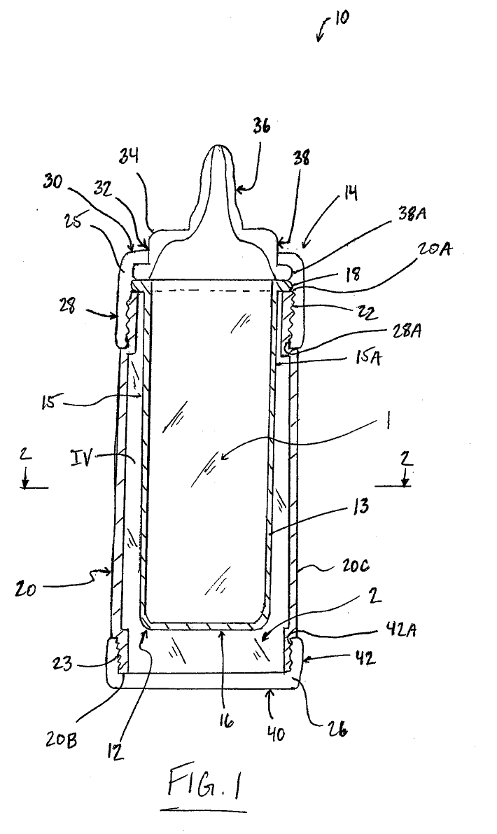

FIG. 2 is a horizontal cross-sectional view taken as if it were taken along line 2-2 in FIG. 1.

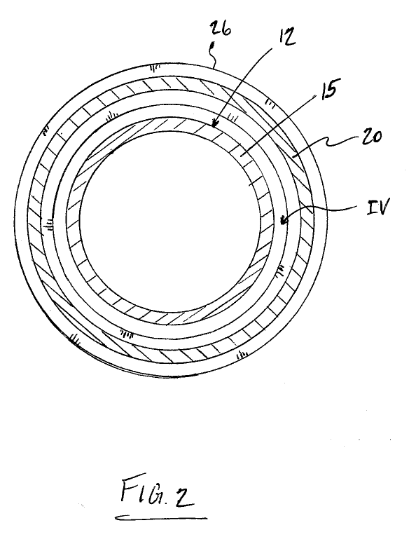

In the drawings like characters of reference indicate corresponding parts in the different figures.

### DETAILED DESCRIPTION

The accompanying figures illustrate a baby bottle generally indicated at reference numeral 10. The baby bottle 10 comprises an interior container 12 where a feeding liquid 1 to be consumed by a baby is received, and an outer container 14 where a heating/warming liquid 2 which has heat is received for heating the feeding liquid by heat transfer through a wall 13 of the interior container 12.

The interior container comprises the wall 13 of plastic material forming a tubular peripheral wall 15 extending longitudinally of the baby bottle with a closed bottom 16 formed unitarily with the peripheral wall that thus collectively form a periphery of the interior container. The interior container is thus open at its top where there is formed a circumferentially extending lip 18 about a full periphery of a top of the peripheral wall 15. The lip 18 protrudes radially outwardly of the peripheral wall 15 beyond an outer face 15A thereof so as to form a ledge for resting on the outer container 14 at its top as will be better appreciated shortly.

In the illustrated embodiment the interior container 12 is made from flexible plastic material and is particularly suited for one-time use so that the container 12 is disposed of after it is emptied of feeding liquid.

Turning now to the outer container of the illustrated embodiment, the outer container 14 comprises a tubular shell 20 enclosing a longitudinal axis of the baby bottle that is open at its top 20A and at its bottom 20B such that the shell 20 forms a peripheral wall of the outer container. An outer face 20C of the shell 20 has mating surfaces 22 and 23 in the form of conventional threads at the top and bottom for receiving cover-like elements 25 and 26, which are also threaded so as to cooperate with the mating surfaces 22 and 23 to close the outer container.

At the top of the outer container there is thus provided a collar 25 defining a first one of the cover-like elements of the outer container. The collar 25 includes a circumferentially extending mating portion 28 with an inside face 28A which is threaded to cooperate with the mating surface 22 at the top of the shell 20. The collar also includes a lid portion 30 spanning inwardly from the mating portion 28 at a periphery of the collar to a central aperture 32.

A conventional nipple 34 as known to a person skilled in the art is provided to close the interior container 12 at its otherwise open top so that the feeding liquid is contained in the interior container but withdrawable therefrom through a stem portion 36 of the nipple. The stem portion 36, which is shaped to generally resemble a mother's nipple, lies generally along the longitudinal axis of the baby bottle in a manner standing upwardly from a base portion 38 of the nipple. The base portion 38 at a bottom of the upstanding stem portion 36 extends radially outwardly therefrom to the lip 18 of the interior container. The base portion 38 forms at its bottom distally to the stem portion 36 a circumferentially extending bottom lip 38A which abuts the lip 18 of the interior container and forms a shoulder of the nipple 34 on which the lid portion 30 of the collar 25 can press downwardly (when it is mated to the shell 20) so as to maintain the nipple 34 and the top of the interior container 12 in sandwiched relation. Thus the collar 25 acts to seal, between itself and the shell 20 at its top terminus, an area where the nipple at its bottom lip 38A meets the interior container at its top lip 18 so that the feeding liquid does not leak through therebetween.

As such, the interior container 12 is connected at its lip 18 to the outer container 14 between the collar 25 and the top terminus 20A of the shell and is held in fixed relation to the outer container.

A lid (not shown) is typically provided at a top of the baby bottle to cover the nipple 34.

The cover-like element at the bottom of the outer container is a removable cap 26 which is similar to the collar 25 but without an aperture therein. As such, the cap 26 includes a lid portion 40 spanning across the open bottom of the shell 20 to close same and a circumferentially extending mating portion 42 with an inside face 42A which is threaded to cooperate with the mating surface 23 at the bottom 20B of the shell 20. The cap 26 may include a compressible sealing material (not shown), such as rubber, forming an annulus matching the shell bottom 20B that is arranged for butting engagement with a face of the bottom terminus 20B of the shell so as to resist leakage between the shell 20 and the cap 26.

Thus the outer container 14 which at its top is defined by the collar 25, at its peripheral wall defined by the tubular shell 20, and at its bottom defined by the removable cap 26 delimits an interior volume IV of the outer container where the interior container 12 is received. The interior container 12 depends into the interior volume IV from its lip 18 resting on the top 20A of the shell to its closed bottom 16 which is held in spaced relation from the bottom of the outer container, that is from the cap 26 at the bottom terminus 20B of the shell 20, such that the closed bottom 16 of the interior container is located intermediate the top and bottom of the outer container albeit closer to the bottom thereof.

A portion of the interior volume IV about the interior container, that is, that space formed between the peripheral walls of the interior and outer containers 12 and 14 and between the interior container's closed bottom 16 and the outer container's bottom closed by the cap 26, is thus arranged for receiving the heating liquid 2 therein. The heating liquid, for example hot water, is placed into communication with the outer surface 15A of the peripheral wall of the interior container so that heat may be transferred from the heating liquid through the wall 13 of the interior container to the feeding liquid 1 therein. The peripheral walls 15, 20 of the interior and outer containers 12, 14 respectively are spaced radially from one another along a full length of the baby bottle so that the heating liquid is able to contact an entirety of the surface 15A of the interior container, including at its closed bottom and that portion near the interior container's top across wherefrom the mating surface 22 is formed on the outer container's peripheral wall which is defined by the shell 20.

Thus the space where the heating liquid 2 may be contained is delimited at a top by a bottom of the lip 18 of the interior container; at sides between the shell 20 and the peripheral wall 15 of the interior container so that the heating liquid can fully surround the interior container along its full length from top to bottom; and at a bottom by the lid portion of the cap 26.

In use, prior to having received any liquid, the baby bottle 10 is partially assembled with the interior container 12 resting by its lip 18 on the top 20A of the shell, such that the baby bottle is oriented with the open top of the interior container facing upwardly. As such, the nipple 34 is removed from the baby bottle or, in other words, not yet installed as part of same. The feeding liquid 1 is transferred to the interior container 12. The nipple 34 may then be placed with its bottom lip 38A against the top of the lip 18 so as to close the interior container, and the collar 25 installed on the shell 20 so as to seal the connection between the nipple and the interior container. The interior container is thus fixedly held in position at its lip 18 between the shell top 20A and the nipple's bottom lip 38A, sandwiched therebetween by the collar 25 installed on the shell 20 by mating surface 22.

The baby bottle is then flipped upside down so that the bottom of the outer container that is currently open (since the removable cap is not installed) is facing upwardly. Once the heating liquid 2 has been heated, for example in a kettle or in a microwave, the heated warming liquid 2 is transferred into the outer container 14 through the bottom thereof to fill the space about the interior container with the heat source for heating the feeding liquid 1. The baby bottle is maintained in its upside down orientation as the removable cap 26 is installed on the bottom 20B of the shell so as to close the outer container.

The baby bottle 10 is thus readied for use, as the heating liquid 2 is maintained in the space about the interior container 12 in communication with the wall 13 thereof so as to transfer heat to heat the feeding liquid which is to be consumed by a baby.

Since various modifications can be made in my invention as herein above described, and many apparently widely different embodiments of same made, it is intended that all matter contained in the accompanying specification shall be interpreted as illustrative only and not in a limiting sense.

1. A baby bottle comprising:
an interior container for containing a feeding liquid that has an open top, a closed bottom, and a peripheral wall spanning therebetween;
a nipple at the open top of the interior container thereby closing the interior container so that the feeding liquid is contained in the interior container but withdrawable therefrom through the nipple;
an outer container having a top, a bottom, and a peripheral wall spanning therebetween that collectively define an interior volume of the outer container;
the interior container being received in the interior volume;
the outer container being arranged for containing a heating liquid which acts as a heat source for heating the feeding liquid by transfer of heat from the heating liquid in communication with an outer surface of the interior container to the feeding liquid contained therein;
the outer container including a removable cap at the bottom thereof such that the heating liquid may be introduced into the outer container through the bottom to a space delimited by the outer container about the interior container when the cap is removed.

2. The baby bottle according to claim 1 wherein the outer container comprises a tubular shell forming the peripheral wall of the outer container that receives at its bottom the removable cap so as to close the outer container at the bottom of the shell.

3. The baby bottle according to claim 1 wherein the removable cap threadably engages an outer face of the peripheral wall of the outer container.

4. The baby bottle according to claim 1 wherein the closed bottom of the interior container is spaced from the bottom of the outer container so as to be located intermediate the top and bottom of the outer container.

5. The baby bottle according to claim 1 wherein the interior container and outer container enclose a longitudinal axis of the baby bottle and wherein the peripheral wall of the outer container is spaced radially from the peripheral wall of the interior container along a length of the interior container from the open top to the bottom thereof.

6. The baby bottle according to claim 1 wherein the interior container is made from a flexible plastic material.

7. The baby bottle according to claim 1 wherein the interior container has at its top a lip at which the interior container is connected to the outer container and from which the interior container depends into the interior volume of the outer container.

8. The baby bottle according to claim 7 wherein the lip is rested on a top of the peripheral wall of the outer container.

9. The baby bottle according to any one of claims 1 further including a collar sandwiching the nipple and the interior container onto the top of the outer container.

10. A method for preparing feeding liquid to be consumed by a baby, the method comprising:
providing a baby bottle comprising:
an interior container for containing a feeding liquid that has an open top, a closed bottom, and a peripheral wall spanning therebetween;
a nipple at the open top of the interior container thereby closing the interior container so that the feeding liquid is contained in the interior container but withdrawable therefrom through the nipple;
an outer container having a top, a bottom, and a peripheral wall spanning therebetween that collectively define an interior volume of the outer container;
the interior container being received in the interior volume;
the outer container being arranged for containing a heating liquid which acts as a heat source for heating the feeding liquid by transfer of heat from the heating liquid in communication with an outer surface of the interior container to the feeding liquid contained therein;
the outer container including a removable cap at the bottom thereof such that the heating liquid may be introduced into the outer container through the bottom to a space delimited by the outer container about the interior container when the cap is removed;
providing the feeding liquid;
providing the heating liquid;
with the nipple removed and the baby bottle oriented such that the open top of the interior container is facing upwardly, transferring the feeding liquid into the interior container allowing the baby food to be consumed therefrom;
with the baby bottle oriented such that the bottom of the outer container is facing upwardly, transferring the heating liquid into the outer container through the bottom thereof as the cap is removed so as to fill the space about the interior container with the heat source for heating the feeding liquid.
